(19) United States
(12) Patent Application Publication
(10) Pub. No.: US 2025/0070588 A1
(43) Pub. Date: Feb. 27, 2025

(54) PARTIAL PRE-CHARGE OF THE HIGH VOLTAGE SYSTEM

(71) Applicant: BAE Systems Controls Inc., Endicott, NY (US)

(72) Inventors: Christopher C. Jones, Vestal, NY (US); Robert J. Vovos, Vestal, NY (US); Arthur P. Lyons, Maine, NY (US); James A. Dupuy, Endicott, NY (US)

(73) Assignee: BAE Systems Controls Inc., Endicott, NY (US)

(21) Appl. No.: 18/236,658

(22) Filed: Aug. 22, 2023

(51) Int. Cl. H02J 7/34; H02J 7/00

(52) U.S. Cl. CPC H02J 7/345; H02J 7/0069; H02J 7/00712; H02J 2207/20

(57) ABSTRACT

A system for partially pre-charging an electrical power system having a high voltage power source, a DC link device with a DC Link capacitor, a low voltage power source and a DC/DC converter. In one embodiment a partial pre-charge of the DC Link capacitor can be achieved in three ways: first, through a DC/DC converter boosting from the low voltage power source, second, through a first circuit provided to charge the DC link capacitor to a partial pre-charge state using the voltage directly from the low voltage power source, and third, through a second circuit provided to limit current flowing to the DC link capacitor from the high voltage power source to charge the DC Link capacitor only to a partial pre-charge level. A controller selectively operates the first circuit, the second circuit, or the DC/DC converter for charging the DC link capacitor to the partial pre-charge state

### BACKGROUND

In a high voltage DC power system, such as for an electric vehicle (EV) or a hybrid electric vehicle (HEV), there is a high voltage energy storage system that is used as a power source to supply energy for propulsion and running accessories. This high voltage energy storage system, which may be a multiple battery pack, ultra-capacitors or other systems, has contactors on its output that prevent high voltage from leaving the high voltage connections until enabled. Connected to this high voltage energy storage system are various devices such as propulsion inverters and DC/DC or DC/AC converters that are used to power the propulsion motor, charge the low voltage battery, and power electrified accessories loads of the vehicle. Within these devices are high voltage DC link capacitors that buffer the high voltage power from the high voltage energy storage system to and from the various loads. The high voltage DC link capacitors are typically pre-charged prior to closing the contactors in the high voltage energy storage system to allow the voltage potential on either side of the contactors to be equalized. The pre-charge minimizes the current flow across the closing contacts of the main DC link contactors connecting the high voltage energy storage to the high voltage DC link in order to avoid damage and maximize contactor life. This pre-charge is performed to the full high voltage energy source voltage.

The contactors are generally open until the high voltage DC link capacitance is pre-charged through a resistive network or other means across these contactors in the high voltage energy storage system. This pre-charge function gradually charges the capacitance in the connected loads prior to closing the contactors.

If not first detected, there may be many failures in the system that can prevent proper operation when the contactors close and high voltage is present

### SUMMARY

To solve this problem, a system and method to partial pre-charge of the high voltage system to a low voltage is disclosed to allow the high voltage system and loads to be thoroughly checked for operational defects prior to engaging the high voltage energy source.

In one embodiment, a system for partially pre-charging an electrical power system is disclosed. The electrical power system includes a high voltage power source module including a high voltage DC power source, a DC link device including a high voltage DC link capacitor connected to the high voltage power source, a low voltage power source connected to the DC link capacitor and a DC/DC converter connected between the DC link capacitor and the low voltage power source. In one embodiment, the DC/DC converter is configured in a boost mode to boost the voltage of the low voltage power source. In one embodiment, a controller is configured to charge the DC link capacitor to a partial pre-charge state from the low voltage power source using the DC/DC converter module in the boost mode.

In one embodiment, the system for partially pre-charging an electrical power system includes a first circuit configured to charge the DC link capacitor to a partial pre-charge state using the voltage from the low voltage power source and a second circuit configured to limit current flowing to the DC link capacitor from the high voltage power source to charge the DC link capacitor to a partial pre-charge state based on the limited current flow. A controller is configured to selectively operate one of the first circuit, the second circuit and the DC/DC converter, for charging the DC link capacitor to the partial pre-charge state.

In one embodiment, the second circuit comprises a pair of contactors for controlling the supply of current to charge the high voltage DC link capacitor and a resistor network and a contactor connected in parallel with one contactor of the pair of contactors and wherein the controller enables the current to flow through the resistor network to gradually charge the DC link capacitor to the partial pre-charge state. In one embodiment, the first circuit comprises a resistor network and a plurality of contactors connected between the DC link capacitor and the low voltage power source and wherein the controller is configured to close the plurality of contactors such that current flows through the resistor network to the DC link capacitor to gradually charge the DC link capacitor to the partial pre-charge state. In one embodiment, the partial pre-charge state is equal to the voltage of the low voltage power source. In one embodiment, the controller is configured to open the plurality of contactors in the first circuit to charge the DC link capacitor to the partial pre-charge state from the low voltage power source using the DC/DC converter module in the boost mode.

In one embodiment, the controller is configured to detect faults in the electrical power system based on measurements from one or more sensors while the DC link capacitor is in the partial pre-charge state. In one embodiment, the controller is configured to disconnect the sensors and activate the second circuit to gradually charge the DC link capacitor from the high voltage power source to charge the DC link capacitor to a full high voltage pre-charge state.

In one embodiment, a method for partially pre-charging the electrical power system includes providing a first circuit configured to charge the DC link capacitor to a partial pre-charge state using the voltage from the low voltage power source, providing a second circuit configured to limit current flowing to the DC link capacitor from the high voltage power source to charge the DC link capacitor to a partial pre-charge state based on the limited current flow and selectively operating one of the first circuit, the second circuit, and the DC/DC converter, for charging the DC link capacitor to the partial pre-charge state.

In one embodiment, the method includes controlling a pair of contactors, a resistor network and a contactor connected in parallel with one contactor of the pair of contactors to limit the current flowing through the resistor network to gradually charge the DC link capacitor to the partial pre-charge state. In one embodiment, the method includes closing a plurality of contactors in the first circuit such that current flows through a resistor network to the DC link capacitor to gradually charge the DC link capacitor to the partial pre-charge state. In one embodiment, the method includes opening a plurality of contactors in the first circuit to charge the DC link capacitor to the partial pre-charge state from the low voltage power source while the DC/DC converter module in the boost mode.

In one embodiment, the method includes detecting faults in the electrical power system based on measurements from at least one sensor while the DC link capacitor is in the partial pre-charge state. In one embodiment, the method includes detecting shorts between high voltage DC harnessing and AC harnessing in the electrical power system while the DC link capacitor is in the partial pre-charge state. In one embodiment, the method includes detecting shorts on the DC link device while the DC link capacitor is in the partial pre-charge state. In one embodiment, the method includes detecting faults in high voltage contactors in the electrical power system while the DC link capacitor is in the partial pre-charge state. In one embodiment, the method includes detecting ground faults in the electrical power system while the DC link capacitor is in the partial pre-charge state. In one embodiment, the method includes detecting faults in high voltage current sensors in the electrical power system while the DC link capacitor is in the partial pre-charge state.

### BRIEF DESCRIPTION OF THE DRAWINGS

FIG. 1 is a block diagram of one embodiment of a system for partially pre-charging an electrical power system of the present disclosure.

FIG. 2 is a block diagram of one embodiment of a system for partially pre-charging an electrical power system of the present disclosure.

FIG. 3 is a flow diagram of a method for partially pre-charging an electrical power system of the present disclosure.

FIG. 4 is a flow diagram of a method for partially pre-charging an electrical power system of the present disclosure.

Further features as well as the structure and operation of various embodiments are described in detail below with reference to the accompanying drawings. In the drawings, like reference numbers indicate identical or functionally similar elements.

### DETAILED DESCRIPTION

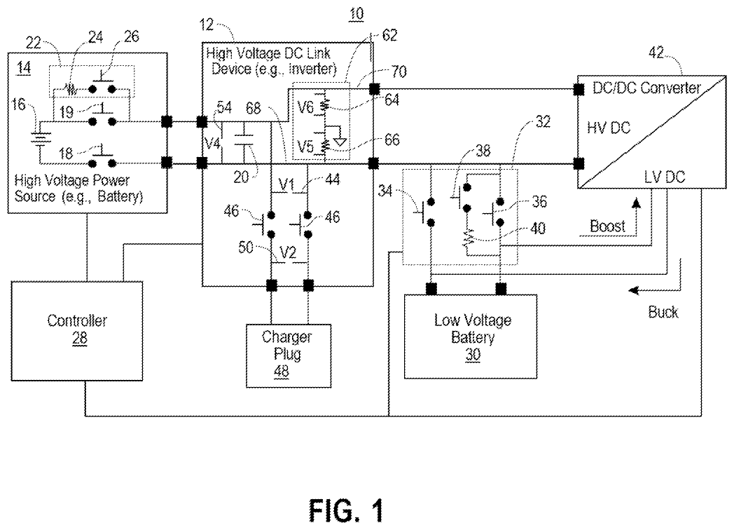

Turning now to FIG. 1, a vehicle power system 10 includes a module containing a high voltage DC link device 12 and a high voltage power source module 14. The high voltage power source module 14 includes a high voltage DC power source 16. The high voltage DC link device 12 includes a high voltage DC link capacitor 20. In some embodiments, the high voltage DC power source 16 may be a high voltage energy storage such as a multiple battery pack for powering an EV or an HEV. In some embodiments, the high voltage DC link device 12 is an inverter of an EV or HEV. In some embodiments, the high voltage power source module 14 includes contactors 18 and 19 for controlling the supply of power to charge the high voltage DC link capacitor 20 included in the high voltage DC link device 12. When contactors 18 and 19 are both closed, the DC link capacitor 20 is charged to the full voltage of the high voltage power source 16 thereby charging the DC link capacitor 20 to a high voltage state. It should be understood that “contactor” may be implemented by an electromechanical switch device or a solid state switch device, as either could also be used in pre-charge circuits described herein. The high voltage power source module 14 may also include a circuit 22 configured to pre-charge the DC link capacitor 20 prior to closing the contactors 18 and 19. In some embodiments, the circuit 22 is configured to gradually charge the DC link capacitor 20 from the high voltage power source 16 to a high voltage state. This pre-charge function is used by those familiar to the art to protect contactors and loads from large currents as the DC Link capacitors charge. If such a “pre-charge” function were not present, damage to contactors 18 and 19 as well as any loads could be damaged upon contactors 18 and 19 being closed. Partial pre-charge reduces the overall arc flash energy at startup which helps reduce the damaging effects of shorts on wires from the battery and other components, thereby increasing the health and reliability of various system components.

In one embodiment, the circuit 22 includes a resistor network 24 and a contactor 26 connected in parallel with contactor 19. To charge the DC link capacitor 20 to the pre-charge state, contactor 19 is opened and contactors 18 and 26 are closed. The resistor network 24 slows the current flowing to the DC link capacitor 20 from the high voltage power source 16 to gradually charge the DC link capacitor 20 to the pre-charge state. In an alternative embodiment, the circuit 22 could be implemented in parallel with contactor 18 instead of contactor 19 and perform a similar function.

In one embodiment, the high voltage DC link capacitor 20 is partially pre-charged to a voltage that is lower than the high voltage power source voltage by limiting the flow of current through the circuit 22. In one embodiment, the duration of the current flowing through the circuit 22 is limited by a controller 28. In one embodiment, the voltage 54 as measured by sensor V4, or a similar sensor on the output of the High Voltage Energy Storage, is used by the controller 28 to measure the voltage and cease pre-charge at the partially pre-charged state. The controller 28 controls the pre-charge activations of the circuit 22 and other test circuits to be described below, having connections through either communication and/or control paths to the various contactors and components of the power system 10 to activate/deactivate them.

In some embodiments, after the pre-charge is begun, the controller 28 operates circuit 22 by opening the contactor 26 after a period of time to cause the DC link capacitor 20 to be charged to a lower voltage 54 as measured by sensor V4 than the full high voltage energy source 16. The state of being charged to a voltage lower than the full voltage of the high voltage energy source 16 is hereinafter identified as the partial pre-charge state. The partial pre-charge state is a lower voltage than the full high voltage energy source 16 to allow various integrity tests on the power system 10 to be performed at a lower voltage. In order to maintain the High Voltage DC Link voltage in a partial pre-charge state during testing, contactor 26 may be reclosed periodically. After the testing is performed in the partial pre-charge state, the controller 28 then recloses the contactor 26 to allow the high voltage DC link capacitor 20 to be pre-charged to the full voltage of the high voltage energy source 16.

In some embodiments, the vehicle power system 10 may also include a low voltage power source 30. In one embodiment, the low voltage power source 30 is a low voltage battery for supplying power to accessories of an EV or HEV. In one embodiment, a circuit 32 including a contactor and resistor arrangement similar to the circuit 22 used on the high voltage energy source module 14 can be used. In this embodiment the partial pre-charge can only bring the voltage of the high voltage DC link capacitor 20 up to that of the low voltage battery 30. The circuit 32 includes contactors 34 and 36 and may include contactor 38 and resistor network 40. During partial pre-charge using the low voltage energy source 30, the high voltage energy source module 14 contactors 18 and 19 are opened, as well as contactor 26, if provided. The partial pre-charge is performed by the controller 28 operating circuit 32 by closing contactors 34 and 38, if present, leaving contactor 36 open so the DC link capacitor 20 can be gradually pre-charged through the resistor network 40 to the voltage of the low voltage energy source 30. If a gradual pre-charge is not required, contactor 38 and resistor network 40 would not be provided, and contactors 34 and 36 may be closed immediately if the contactors 34 and 36 are designed to carry the current at closure. After the partial pre-charge state is reached, the controller 28 may open contactors 34, 36 and 38 to isolate the low voltage energy source 30 to allow various integrity tests on the power system 10 to be performed at this voltage. In order to maintain the High Voltage DC Link voltage in a partial pre-charge state during testing, contactors 34, 36, and 38 may be reclosed periodically. After testing is performed, the controller 28 can then operate circuit 22 to complete the full pre-charge of the DC link capacitor 20.

In some embodiments, the vehicle power system 10 may also include a DC/DC converter module 42 connected between the high voltage DC link device 12 and the low voltage power source 30. In one embodiment, the DC/DC converter 42 can take current from the high voltage energy source 16 to the low voltage energy source 30 in a buck mode, which is useful to charge the low voltage battery 30 during operation, however it is not required for this embodiment. In one embodiment, the DC/DC converter module 42 can take current from the low voltage energy source 30 to the high voltage energy source 16 in boost mode. The partial pre-charge using the DC/DC Converter 42 in boost mode charges the connected electronics, harnessing, and any other DC loads to a voltage where sensors on the system can verify the high voltage system integrity prior to a full pre-charge and closure of the high voltage energy source contactors 18 and 19. The controller 28 regulates the high voltage DC link device 12 through the DC/DC converter 42 passing or even boosting the voltage from a low voltage energy source 30 to charge the high voltage DC link capacitor 20.

The low voltage battery resistor network 32 is disconnected in the case where the DC/DC converter is used to boost the low voltage battery 30. In the DC/DC converter boost mode, all contactors 34, 38, and 36 are open In one embodiment, the resistor network 32 would be used to pre-charge the DC link capacitor 20 if a DC/DC converter is not present in the system. In another embodiment, if the DC/DC converter 42 could only buck voltage, not boost, the resistor network 32 would be used to charge the low voltage battery 30 from the high voltage source 16. There are three independent methods of partial pre-charge: 1) Use circuit 22; 2) Use circuit 32; and 3). Use the DC/DC 42. The three methods are activated independently by controller 28. All contactors are open on circuits 22 and 32 when boost is used, all contactors in circuit 22 are open and boost disabled when circuit 32 is used, and all contactors in circuit 32 are open and boost disabled when circuit 22 is used. The architecture shown in FIG. 1 includes hardware to support all three methods. In other embodiments, the architecture may include any two of the methods combined, or only one method to allow the partial pre-charge state to be established. For example, in one embodiment, circuit 32 is not included so that the partial pre-charge state is established by the boost mode of the DC/DC converter 42 or the use of circuit 22. In another embodiment, DC/DC converter 42 is not included so that the partial pre-charge state is established by use of circuit 32 or circuit 22. In another embodiment, neither of the DC/DC converter 42 nor the circuit 32 are included so that the partial pre-charge state is established by use of circuit 22.

In some embodiments, voltage sensors 44 and 50 for sensing voltages V1 and V2 can be used to detect several faults at the partial pre-charge voltage. In one embodiment, when the high voltage DC link capacitor 20 is in the partial pre-charge state, high voltage shorts across the DC link device 12 can be detected by a sensor 44. Controller 28 may be programmed to determine whether voltage V1 rises during the partial pre-charge process and if voltage V1 fails to rise a fault will be identified. In another embodiment, the contactors 46 protecting against high voltage exposure at an off-board charger vehicle plug 48 can be closed and the voltage V2 can be measured by sensor 50. The controller 28 determines whether voltage V2 is equal to V1 on the outside of the contactors 46 to ensure their function as well as assess for shorts on the charger plug 48 side of the contactors 46. Similarly, other sensors can be placed around the system 10 to implement the testing as is commonly done by one skilled in the art of propulsion system design.

During the partial pre-charge, chassis faults may be measured by methods common to the industry, for example, DC ground or vehicle chassis faults could be detected using circuit 62 on the high voltage DC link device 12. The controller 28 is programmed to look for a shift in the voltage with reference to the chassis of the vehicle. A no fault condition will exist when the voltage V5 across resistor 64 and voltage V6 across an identical resistor 66 are equal and with voltages V5 and V6 each being half the DC link capacitor voltage, where the voltage V5 measures the voltage between the negative DC link line 68 and chassis ground and voltage V6 measures the voltage between the positive DC link line 70 and chassis ground. When a short to ground appears in the system the voltages V5 and V6 will no longer be equal. For example, if chassis is shorted to the negative DC link line 68 V5 will equal 0V and V6 will read the full DC link voltage. If the chassis was shorted to the positive DC link line 70, V6 will equal 0V, and V5 will be the full negative DC link voltage. After testing is completed, the controller 28 is configured to disconnect the sensors and test circuits and activate the circuit 22 to gradually charge the DC link capacitor 20 from the high voltage power source 16 to charge the DC link capacitor 20 to a full high voltage pre-charge state.

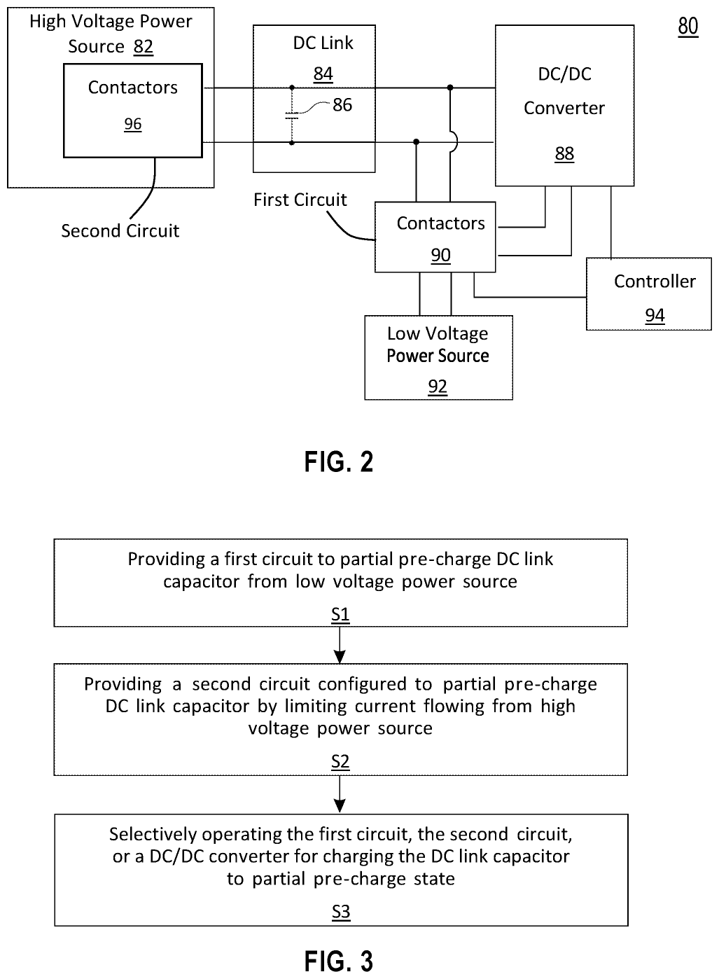

In one embodiment, as shown in FIG. 2, a system 80 for partially pre-charging an electrical power system includes a high voltage power source 82 having a second circuit 96, a DC link device 84, having a high voltage DC link capacitor 86, connected to contactors of the second circuit 96 of the high voltage power source 82, and a DC/DC converter 88 connected between the DC link device 84 and a low voltage power source 92 through a first circuit 90. The DC/DC converter 88 is configured in a boost mode to boost the voltage of the low voltage power source 92. A controller 94 is configured to charge the DC link capacitor 86 to a partial pre-charge state from the low voltage power source 92 using the DC/DC converter 88 in the boost mode. In one embodiment, the controller 94 leaves the normally opened contactors of first circuit 90 open to charge the DC link capacitor 86 to the partial pre-charge state from the low voltage power source 92 using the DC/DC converter 88 in the boost mode. Alternatively, the controller 94 closes the contactors 90 to charge the DC link capacitor 86 to the partial pre-charge state directly from the low voltage power source 92.

FIG. 3 is a flow diagram of one embodiment of a method for partially pre-charging an electrical power system that includes a high voltage power source module including a high voltage DC power source, a DC link device connected to the high voltage power source, the DC link device including a high voltage DC link capacitor, a low voltage power source connected to the DC link capacitor and a DC/DC converter connected between the DC link capacitor and the low voltage power source. The method includes step S1 of providing a first circuit configured to charge the DC link capacitor to a partial pre-charge state using the voltage from the low voltage power source and step S2 of providing a second circuit configured to limit current flowing to the DC link capacitor from the high voltage power source to charge the DC link capacitor to a partial pre-charge state based on the limited current flow. Step S3 includes selectively operating the first circuit, the second circuit, or the DC/DC converter, for charging the DC link capacitor to the partial pre-charge state.

In one embodiment, charging the DC link capacitor to the partial pre-charge state in step S3 includes using the DC/DC converter 88 to charge the DC link capacitor 86 to the partial pre-charge state from the low voltage power source 92 while the DC/DC converter 88 is in the boost mode. In one embodiment of step S3, contactors in the first circuit 90 may be open or not present and contactors in the second circuit 96 also remain open.

In one embodiment, charging the DC link capacitor to the partial pre-charge state in step S3 includes controlling the second circuit 96 which may include a pair of contactors, a resistor network and a contactor connected in parallel with one contactor of the pair of contactors to limit the current flowing through the resistor network to gradually charge the DC link capacitor 86 to the partial pre-charge state from a High Voltage Power Source 82.

In one embodiment, charging the DC link capacitor 86 to the partial pre-charge state in step S3 using the first circuit 90 includes closing a plurality of contactors in the first circuit such that current flows through a resistor network to the DC link capacitor 86 to gradually charge the DC link capacitor to the partial pre-charge state from a Low Voltage Power Source 92.

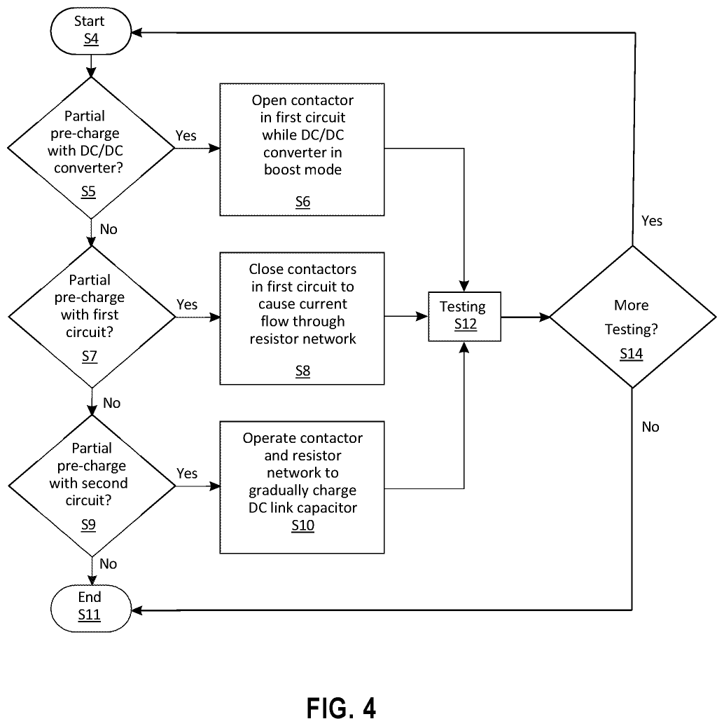

FIG. 4 is a flow diagram of one embodiment of the selective operation of the partial pre-charge state process of step S3. In step S4, the selective partial pre-charge state process is started. In step S5, the controller determines if the DC/DC converter is selected for charging the DC link capacitor to the partial pre-charge state. If the DC/DC converter is selected, YES in step S5, the method moves to step S6 where the controller opens a plurality of contactors in the first circuit to charge the DC link capacitor to the partial pre-charge state from the low voltage power source while the DC/DC converter module in the boost mode. If the DC/DC converter is not selected, NO in step S5, the method moves to step S7 where the controller determines if the first circuit is selected for charging the DC link capacitor to the partial pre-charge state. If the first circuit is selected, YES in step S7, the method moves to step S8 where the controller closes a plurality of contactors in the first circuit such that current flows through a resistor network to the DC link capacitor to gradually charge the DC link capacitor to the partial pre-charge state. If the first circuit is not selected, NO in step S7, the method moves to step S9 where controller determines if the second circuit is selected for charging the DC link capacitor to the partial pre-charge state. If the second circuit is selected, YES in step S9, the method moves to step S10 where the controller operates a pair of contactors, a resistor network and a contactor connected in parallel with one contactor of the pair of contactors to limit the current flowing through the resistor network to gradually charge the DC link capacitor to the partial pre-charge state. If the second circuit is not selected, NO in step S9, the method ends at step S11.

The method of charging the DC link capacitor to the partial pre-charge state in either of steps S6, S8 or S10, enables various tests of the electrical power system to be conducted in a step S12 at a lower voltage. Conducing the tests at the partial pre-charge reduces the damaging effects of shorts on wires and other faults at components.

In one embodiment, step S12 includes detecting faults in the electrical power system based on measurements from at least one sensor while the DC link capacitor is in the partial pre-charge state. In one embodiment, step S12 includes detecting shorts between high voltage DC harnessing and AC harnessing in the electrical power system while the DC link capacitor is in the partial pre-charge state. In one embodiment, step S12 includes detecting shorts on the DC link device while the DC link capacitor is in the partial pre-charge state. In one embodiment, step S12 includes detecting a disconnected high voltage harness while the DC link capacitor is in the partial pre-charge state. In one embodiment, step S12 includes detecting faults in high voltage contactors in the electrical power system while the DC link capacitor is in the partial pre-charge state. In one embodiment, step S12 includes detecting ground faults in the electrical power system while the DC link capacitor is in the partial pre-charge state. In one embodiment, step S12 includes detecting faults in high voltage current sensors in the electrical power system while the DC link capacitor is in the partial pre-charge state. In one embodiment, step S12 includes detecting faults in high voltage energy storage offboard charger interface while the DC link capacitor is in the partial pre-charge state.

Step S14 is required during testing if additional transitions of the first circuit (S5 to S6) and second circuit (S7 to S8) may be required to return the DC Link capacitor to the partial pre-charge state as the DC link capacitor is discharged during testing. Step S10 using the DC/DC converter has the benefit of continuously maintaining the DC link device in the partial pre-charge state and S14 may not be required.

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A system for partially pre-charging an electrical power system comprising:
a high voltage power source module including a high voltage DC power source;
a DC link device connected to the high voltage power source, the DC link device including a high voltage DC link capacitor;
a low voltage power source;
a DC/DC converter connected between the DC link capacitor and the low voltage power source, the DC/DC converter being configured to boost the voltage of the low voltage power source;
a first circuit configured to charge the DC link capacitor to a partial pre-charge state using the voltage from the low voltage power source;
a second circuit configured to limit current flowing to the DC link capacitor from the high voltage power source to charge the DC link capacitor to a partial pre-charge state based on the limited current flow from the high voltage power source; and
a controller configured to selectively operate the first circuit, the second circuit or the DC/DC converter, for charging the DC link capacitor to the partial pre-charge state.

2. The system of claim 1, wherein the second circuit comprises a pair of contactors for controlling the supply of power to charge the high voltage DC link capacitor and a resistor network and a contactor connected in parallel with one contactor of the pair of contactors and wherein the controller limits the duration of current flowing through the resistor network to gradually charge the DC link capacitor to the partial pre-charge state.

3. The system of claim 1, wherein the first circuit comprises a resistor network and a plurality of contactors connected between the DC link capacitor and the low voltage power source and wherein the controller is configured to close the plurality of contactors such that current flows through the resistor network to the DC link capacitor to charge the DC link capacitor to the partial pre-charge state.

4. The system of claim 3, wherein the partial pre-charge state is equal to the voltage of the low voltage power source.

5. The system of claim 3, wherein the controller is configured to open the plurality of contactors in the first circuit to charge the DC link capacitor to the partial pre-charge state from the low voltage power source using the DC/DC converter module.

6. The system of claim 1, further comprising at least one sensor and wherein the controller is configured to detect faults in the electrical power system based on measurements from the at least one sensor while the DC link capacitor is in the partial pre-charge state.

7. The system of claim 6, wherein the controller is configured to activate the second circuit to charge the DC link capacitor from the high voltage power source to charge the DC link capacitor to a full high voltage pre-charge state.

8. A system for partially pre-charging an electrical power system comprising:
a high voltage power source module including a high voltage DC power source;
a DC link device connected to the high voltage power source, the DC link device including a high voltage DC link capacitor;
a low voltage power source;
a DC/DC converter connected between the DC link capacitor and the low voltage power source, the DC/DC converter being configured to boost the voltage of the low voltage power source; and
a controller configured to charge the DC link capacitor to a partial pre-charge state from the low voltage power source using the DC/DC converter module.

9. A method for partially pre-charging an electrical power system, the system comprising a high voltage power source module including a high voltage DC power source, a DC link device connected to the high voltage power source, the DC link device including a high voltage DC link capacitor, a DC/DC converter connected between the DC link capacitor and a low voltage power source, the method comprising:
providing a first circuit configured to charge the DC link capacitor to a partial pre-charge state using the voltage from the low voltage power source;
providing a second circuit configured to limit current flowing to the DC link capacitor from the high voltage power source to charge the DC link capacitor to a partial pre-charge state based on the limited current flow; and
selectively operating one of the first circuit, the second circuit, or the DC/DC converter, for charging the DC link capacitor to the partial pre-charge state.

10. The method of claim 9, wherein charging the DC link capacitor to the partial pre-charge state using the second circuit comprises controlling a pair of contactors, a resistor network and a contactor connected in parallel with one contactor of the pair of contactors to limit the current from the high voltage power source by flowing it through the resistor network to gradually charge the DC link capacitor to the partial pre-charge state.

11. The method of claim 9, wherein charging the DC link capacitor to the partial pre-charge state using the first circuit comprises closing a plurality of contactors in the first circuit such that current flows through a resistor network to limit the current from the low voltage power source to the DC link capacitor to gradually charge the DC link capacitor to the partial pre-charge state.

12. The method of claim 9, wherein charging the DC link capacitor to the partial pre-charge state using the DC/DC converter comprises opening a plurality of contactors in the first circuit to charge the DC link capacitor to the partial pre-charge state from the low voltage power source using the DC/DC converter module.

13. The method of claim 9, further comprising detecting faults in the electrical power system based on measurements from at least one sensor while the DC link capacitor is in the partial pre-charge state.

14. The method of claim 11, further comprising detecting shorts between high voltage DC harnessing and AC harnessing in the electrical power system while the DC link capacitor is in the partial pre-charge state.

15. The method of claim 11, further comprising detecting shorts on the DC link device while the DC link capacitor is in the partial pre-charge state.

16. The method of claim 11, further comprising detecting faults in high voltage contactors in the electrical power system while the DC link capacitor is in the partial pre-charge state.

17. The method of claim 11, further comprising detecting ground faults in the electrical power system while the DC link capacitor is in the partial pre-charge state.

18. The method of claim 11, further comprising detecting faults in high voltage current sensors in the electrical power system while the DC link capacitor is in the partial pre-charge state.

19. The method of claim 11, further comprising detecting faults in high voltage contactors in the electrical interface to offboard chargers while the DC link capacitor is in the partial pre-charge state.

20. A system for partially pre-charging an electrical power system comprising:
a high voltage power source module including a high voltage DC power source;
a DC link device connected to the high voltage power source, the DC link device including a high voltage DC link capacitor;
a low voltage power source;
a circuit configured to limit current flowing to the DC link capacitor from the high voltage power source to charge the DC link capacitor to a partial pre-charge state based on the limited current flow; and
a controller configured to selectively operate the circuit for charging the DC link capacitor to the partial pre-charge state.

21. A system for partially pre-charging an electrical power system comprising:
a high voltage power source module including a high voltage DC power source;
a DC link device connected to the high voltage power source, the DC link device including a high voltage DC link capacitor;
a low voltage power source
a circuit configured to charge the DC link capacitor to a partial pre-charge state using the voltage from the low voltage power source; and
a controller configured to selectively operate the circuit for charging the DC link capacitor to the partial pre-charge state.
